(19) United States
(12) Patent Application Publication
(10) Pub. No.: US 2019/0243922 A1
(43) Pub. Date: Aug. 8, 2019

(54) Personalizing a Meal Kit Service Using Limited Recipe and Ingredient Options

(71) Applicant: International Business Machines Corporation, Armonk, NY (US)

(72) Inventors: Florian Pinel, New York, NY (US); Donna K. Byron, Petersham, MA (US); Benjamin L. Johnson, Baltimore, MD (US); Christian Ewen, New York, NY (US)

(21) Appl. No.: 15/890,874

(22) Filed: Feb. 7, 2018

(51) Int. Cl. G06F 17/30; G06N 5/04; G06Q 30/06

(52) U.S. Cl. CPC G06F 17/30867; G06Q 30/0631; G06N 5/04; G06F 17/3043

(57) ABSTRACT

A method, system and computer-usable medium for performing a meal kit personalization operation, comprising: receiving recipe purchase history information for a plurality of customers; associating the recipe purchase history information with a plurality of input recipes; identifying a plurality of input recipes for use for a particular time period; identifying elements of the input recipes that limit appeal of each of the plurality of input recipes for the particular time period, the elements being identified using purchase predictor information relating to the elements; generating alternative recipes based upon the input recipes; and selecting a predefined number of these input recipes and alternative recipes for presentation to a particular user.

### BACKGROUND OF THE INVENTION

### Field of the Invention

The present invention relates in general to the field of computers and similar technologies, and in particular to software utilized in this field. Still more particularly, it relates to a method, system and computer-usable medium for personalizing a meal kit service using limited recipe and ingredient options.

### Description of the Related Art

Meal kits typically have ingredients and instructions on how to prepare the ingredients into a meal. Consumers typically purchase such a kit because it is convenient, and with the instructions it may be easier to prepare than preparing a meal from scratch. Such kits have many benefits. Often they may be faster to prepare than a conventional meal, and may have less waste or leftover materials. For particularly complicated meals, they may be more economical, as the kit producer is able to prepare the ingredients for many kits at a per kit cost less than the amount a consumer would pay if the consumer purchased all of the ingredients individually.

Meal kit delivery services are growing in popularity. With such a delivery service, for a particular period of time (typically a week) a user can select from a few recipes (typically three) from a relatively small selection of recipes (typically between six and twelve). If the user cannot find enough recipes that they like they can opt out of the delivery service for the current period of time. For each selected recipe the user is provided with a package containing the proportioned ingredients as well as the preparation instructions (i.e., the recipe).

### SUMMARY OF THE INVENTION

A method, system and computer-usable medium are disclosed for performing a meal kit personalization operation, comprising: receiving recipe purchase history information for a plurality of customers; associating the recipe purchase history information with a plurality of input recipes; identifying a plurality of input recipes for use for a particular time period; identifying elements of the input recipes that limit appeal of each of the plurality of input recipes for the particular time period, the elements being identified using purchase predictor information relating to the elements; generating alternative recipes based upon the input recipes; and selecting a predefined number of these input recipes and alternative recipes for presentation to a particular user.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of one illustrative embodiment of a question/answer (QA) system.

FIG. 2 shows a simplified block diagram of an information processing system capable of performing computing operations.

FIG. 3 shows a block diagram of a meal kit personalization environment.

FIG. 4 is a generalized flowchart of the operation of meal kit personalization operation.

### DETAILED DESCRIPTION

Various aspects of the present disclosure include an appreciation that with many meal kit delivery services, the path to profitability resides in shortening the supply chain, reducing food waste and using a limited number of recipes and ingredients. However, sales can be increased by providing more personalized recipes, as consumers are likely to opt out of a given time period (or even leave the service permanently) if they can't find recipes they like. While these constraints can be somewhat contradictory, it would be desirable to identify a way of reconciling them.

The present invention may be a system, a method, and/or a computer program product. In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the present invention may take the form of computer program product embodied in a computer readable storage medium, or media, having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer, or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a sub-system, module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

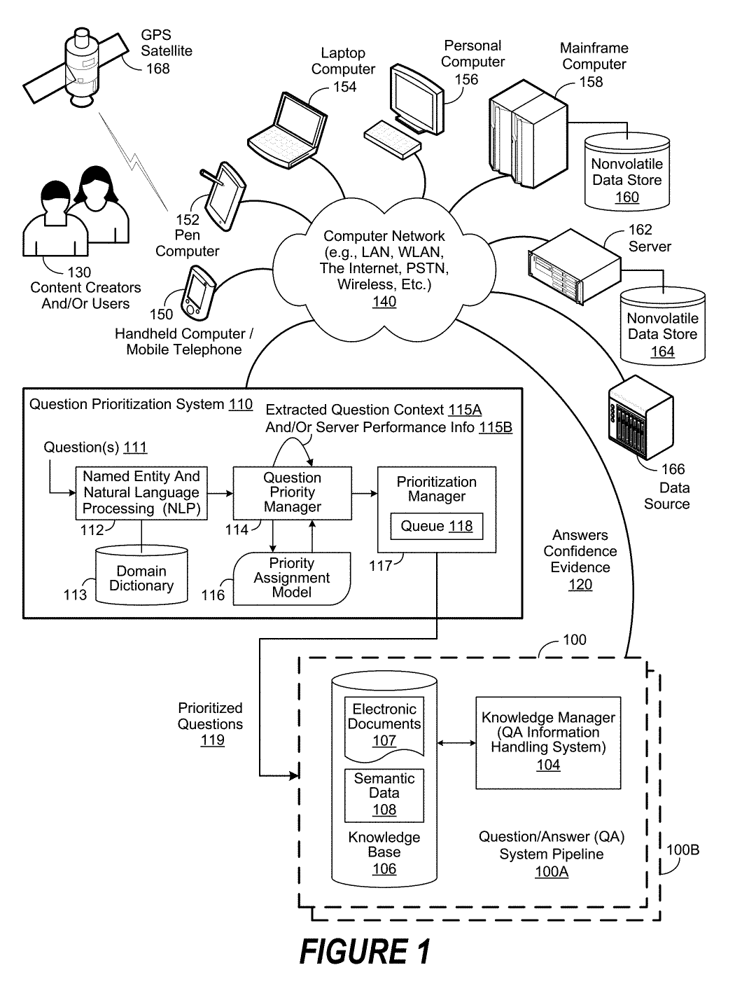

FIG. 1 shows a schematic diagram of one illustrative embodiment of a question/answer (QA) system 100 and a question prioritization system 110 connected to a computer network 140. The QA system 100 includes a knowledge manager 104 that is connected to a knowledge base 106 and configured to provide question/answer (QA) generation functionality for one or more content creators and/or users 130 who submit content across the network 140 to the QA system 100. To assist with efficient sorting and presentation of questions to the QA system 100, the question prioritization system 110 may be connected to the computer network 140 to receive user questions, and may include a plurality of subsystems which interact with cognitive systems, like the QA system 100, to prioritize questions or requests being submitted to the QA system 100.

The Named Entity subsystem 112 receives and processes each question 111 by using natural language processing (NLP) to analyze each question and extract question topic information contained in the question, such as named entities, phrases, urgent terms, and/or other specified terms which are stored in one or more domain entity dictionaries 113. By leveraging a plurality of pluggable domain dictionaries 113 relating to different domains or areas (e.g., travel, healthcare, electronics, game shows, financial services, etc.), the domain dictionary 113 enables critical and urgent words (e.g., “threat level”) from different domains (e.g., “travel”) to be identified in each question based on their presence in the domain dictionary 113. To this end, the Named Entity subsystem 112 may use an NLP routine to identify the question topic information in each question. As used herein, “NLP” broadly refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input. For example, NLP can be used to derive meaning from a human-oriented question such as, “What is tallest mountain in North America?” and to identify specified terms, such as named entities, phrases, or urgent terms contained in the question. The process identifies key terms and attributes in the question and compares the identified terms to the stored terms in the domain dictionary 113.

The Question Priority Manager subsystem 114 performs additional processing on each question to extract question context information 115A. In addition, or in the alternative, the Question Priority Manager subsystem 114 may also extract server performance information 115B for the question prioritization system 110 and/or QA system 100. In selected embodiments, the extracted question context information 115A may include data that identifies the user context and location when the question was submitted or received. For example, the extracted question context information 115A may include data that identifies the user who submitted the question (e.g., through login credentials), the device or computer which sent the question, the channel over which the question was submitted, or any combination thereof. Other examples may include the location of the user or device that sent the question, any special interest location indicator (e.g., hospital, public-safety answering point, etc.), other context-related data for the question, or any combination thereof. In certain embodiments, the location information is determined through the use of a Geographical Positioning System (GPS) satellite 168. In these embodiments, a handheld computer or mobile telephone 150, or other device, uses signals transmitted by the GPS satellite 168 to generate location information, which in turn is provided via the computer network 140 to the Question Priority Manager subsystem 114 for processing.

In various embodiments, the source for the extracted context information 115A may be a data source 166 accessed through the computer network 140. Examples of a data source 166 include systems that provide telemetry information, such as medical information collected from medical equipment used to monitor a patient's health, environment information collected from a facilities management system, or traffic flow information collected from a transportation monitoring system. In certain embodiments, the data source 166 may be a storage area network (SAN) or other network-based repositories of data.

In various embodiments, the data source 166 may provide data directly or indirectly collected from “big data” sources. In general, big data refers to a collection of datasets so large and complex that traditional database management tools and data processing approaches are inadequate. These datasets can originate from a wide variety of sources, including computer systems (e.g., 156, 158, 162), mobile devices (e.g., 150, 152, 154), financial transactions, streaming media, social media, as well as systems (e.g., 166) commonly associated with a wide variety of facilities and infrastructure (e.g., buildings, factories, transportation systems, power grids, pipelines, etc.). Big data, which is typically a combination of structured, unstructured, and semi-structured data poses multiple challenges, including its capture, curation, storage, transfer, search, querying, sharing, analysis and visualization.

The Question Priority Manager subsystem 114 may also determine or extract selected server performance data 115B for the processing of each question. In certain embodiments, the server performance information 115B may include operational metric data relating to the available processing resources at the question prioritization system 110 and/or QA system 100, such as operational or run-time data, CPU utilization data, available disk space data, bandwidth utilization data, and so forth. As part of the extracted information 115A/B, the Question Priority Manager subsystem 114 may identify the Service Level Agreement (SLA) or Quality of Service (QoS) processing requirements that apply to the question being analyzed, the history of analysis and feedback for the question or submitting user, and the like. Using the question topic information and extracted question context 115A and/or server performance information 115B, the Question Priority Manager subsystem 114 is configured to populate feature values for the Priority Assignment Model 116. In various embodiments, the Priority Assignment Model 116 provides a machine learning predictive model for generating target priority values for the question, such as by using an artificial intelligence (AI) approaches known to those of skill in the art. In certain embodiments, the AI logic is used to determine and assign a question urgency value to each question for purposes of prioritizing the response processing of each question by the QA system 100.

The Prioritization Manager subsystem 117 performs additional sort or rank processing to organize the received questions based on at least the associated target priority values such that high priority questions are put to the front of a prioritized question queue 118 for output as prioritized questions 119. In the question queue 118 of the Prioritization Manager subsystem 117, the highest priority question is placed at the front of the queue for delivery to the assigned QA system 100. In selected embodiments, the prioritized questions 119 from the Prioritization Manager subsystem 117 that have a specified target priority value may be assigned to a particular pipeline (e.g., QA system pipeline 100A, 100B) in the QA system 100. As will be appreciated, the Prioritization Manager subsystem 117 may use the question queue 118 as a message queue to provide an asynchronous communications protocol for delivering prioritized questions 119 to the QA system 100. Consequently, the Prioritization Manager subsystem 117 and QA system 100 do not need to interact with a question queue 118 at the same time by storing prioritized questions in the question queue 118 until the QA system 100 retrieves them. In this way, a wider asynchronous network supports the passing of prioritized questions 119 as messages between different QA system pipelines 100A, 100B, connecting multiple applications and multiple operating systems. Messages can also be passed from queue to queue in order for a message to reach the ultimate desired recipient. An example of a commercial implementation of such messaging software is IBM's WebSphere MQ (previously MQ Series). In selected embodiments, the organizational function of the Prioritization Manager subsystem 117 may be configured to convert over-subscribing questions into asynchronous responses, even if they were asked in a synchronized fashion.

The QA system 100 may include one or more QA system pipelines 100A, 100B, each of which includes a computing device 104 comprising one or more processors and one or more memories. The QA system pipelines 100A, 100B may likewise include potentially any other computing device elements generally known in the art including buses, storage devices, communication interfaces, and the like. In various embodiments, these computing device elements may be implemented to process questions received over the network 140 from one or more content creator and/or users 130 at computing devices (e.g., 150, 152, 154, 156, 158, 162). In certain embodiments, the one or more content creator and/or users 130 are connected over the network 140 for communication with each other and with other devices or components via one or more wired and/or wireless data communication links, where each communication link may comprise one or more of wires, routers, switches, transmitters, receivers, or the like. In this networked arrangement, the QA system 100 and network 140 may enable question/answer (QA) generation functionality for one or more content users 130. Other embodiments of QA system 100 may be used with components, systems, sub-systems, and/or devices other than those that are depicted herein.

In each QA system pipeline 100A, 100B, a prioritized question 119 is received and prioritized for processing to generate an answer 120. In sequence, prioritized questions 119 are de-queued from the shared question queue 118, from which they are de-queued by the pipeline instances for processing in priority order rather than insertion order. In selected embodiments, the question queue 118 may be implemented based on a “priority heap” data structure. During processing within a QA system pipeline (e.g., 100A, 100B), questions may be split into multiple subtasks, which run concurrently. In various embodiments, a single pipeline instance may process a number of questions concurrently, but only a certain number of subtasks. In addition, each QA system pipeline 100A, 100B may include a prioritized queue (not shown) to manage the processing order of these subtasks, with the top-level priority corresponding to the time that the corresponding question started (i.e., earliest has highest priority). However, it will be appreciated that such internal prioritization within each QA system pipeline 100A, 100B may be augmented by the external target priority values generated for each question by the Question Priority Manager subsystem 114 to take precedence, or ranking priority, over the question start time. In this way, more important or higher priority questions can “fast track” through a QA system pipeline 100A, 100B if it is busy with already-running questions.

In the QA system 100, the knowledge manager 104 may be configured to receive inputs from various sources. For example, knowledge manager 104 may receive input from the question prioritization system 110, network 140, a knowledge base or corpus of electronic documents 107 or other data, semantic data 108, content creators, and/or users 130, and other possible sources of input. In selected embodiments, some or all of the inputs to knowledge manager 104 may be routed through the network 140 and/or the question prioritization system 110. The various computing devices (e.g., 150, 152, 154, 156, 158, 162) on the network 140 may include access points for content creators and/or users 130. Some of the computing devices may include devices for a database storing a corpus of data as the body of information used by the knowledge manager 104 to generate answers to cases. The network 140 may include local network connections and remote connections in various embodiments, such that knowledge manager 104 may operate in environments of any size, including local (e.g., a LAN) and global (e.g., the Internet). Additionally, knowledge manager 104 serves as a front-end system that can make available a variety of knowledge extracted from or represented in documents, network-accessible sources and/or structured data sources. In this manner, some processes populate the knowledge manager, with the knowledge manager also including input interfaces to receive knowledge requests and respond accordingly.

In one embodiment, a content creator 130 creates content (e.g., a document) in a knowledge base 106 for use as part of a corpus of data used in conjunction with knowledge manager 104. In selected embodiments, the knowledge base 106 may include any file, text, article, or source of data (e.g., scholarly articles, dictionary definitions, encyclopedia references, and the like) for use by the knowledge manager 104. Content users 130 may access the knowledge manager 104 via a network connection or an Internet connection to the network 140, and may input questions to the knowledge manager 104 that may be answered by the content in the corpus of data.

As further described below, when a process evaluates a given section of a document for semantic content, the process can use a variety of conventions to query it from the knowledge manager 104. One convention is to send a well-formed question. As used herein, semantic content broadly refers to content based upon the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager 104. In various embodiments, the knowledge manager 104 may interpret the question and provide a response to the content user containing one or more answers to the question. In some embodiments, the knowledge manager 104 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input prioritized question 119 and the language used in each of the portions of the corpus of data found during the application of the queries using a variety of reasoning algorithms. There may be hundreds or even thousands of reasoning algorithms applied, each of which performs different analysis (e.g., comparisons), and generates a score. For example, certain reasoning algorithms may look at the matching of terms and synonyms within the language of the input question and the found portions of the corpus of data. Other reasoning algorithms may look at temporal or spatial features in the language, while yet others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 100 then generates an output response or answer 120 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

Types of information processing systems that can utilize QA system 100 range from small handheld devices, such as handheld computer/mobile telephone 150 to large mainframe systems, such as mainframe computer 158. Examples of handheld computer 150 include personal digital assistants (PDAs), personal entertainment devices, such as MP3 players, portable televisions, and compact disc players. Other examples of information processing systems include pen, or tablet, computer 152, laptop, or notebook, computer 154, personal computer system 156, server 162, and mainframe computer 158.

As shown, the various information processing systems can be networked together using computer network 140. Types of computer network 140 that can be used to interconnect the various information processing systems include Personal Area Networks (PANs), Local Area Networks (LANs), Wireless Local Area Networks (WLANs), the Internet, the Public Switched Telephone Network (PSTN), other wireless networks, and any other network topology that can be used to interconnect the information processing systems.

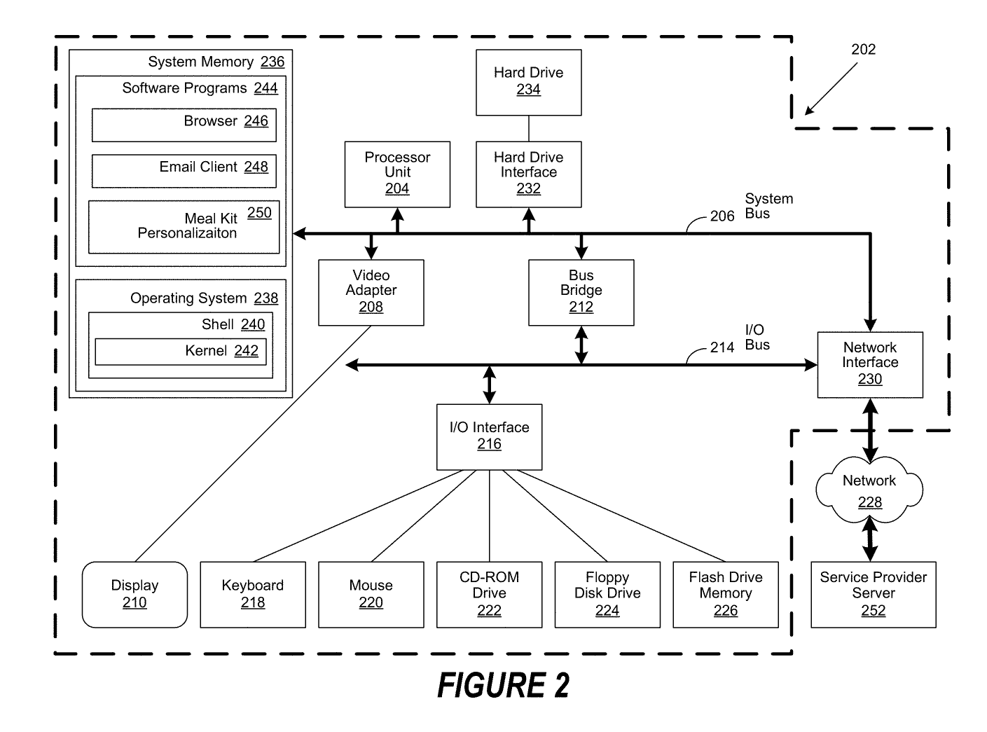

In selected embodiments, the information processing systems include nonvolatile data stores, such as hard drives and/or nonvolatile memory. Some of the information processing systems may use separate nonvolatile data stores. For example, server 162 utilizes nonvolatile data store 164, and mainframe computer 158 utilizes nonvolatile data store 160. The nonvolatile data store can be a component that is external to the various information processing systems or can be internal to one of the information processing systems. An illustrative example of an information processing system showing an exemplary processor and various components commonly accessed by the processor is shown in FIG. 2.

In various embodiments, the QA system 100 is implemented to receive a variety of data from various computing devices (e.g., 150, 152, 154, 156, 158, 162) and data sources 166, which in turn is used to perform QA operations described in greater detail herein. In certain embodiments, the QA system 100 may receive a first set of information from a first computing device (e.g., laptop computer 154). The QA system 100 then uses the first set of data to perform QA processing operations resulting in the generation of a second set of data, which in turn is provided to a second computing device (e.g., server 162). In response, the second computing device may process the second set of data to generate a third set of data, which is then provided back to the QA system 100. In turn, the QA system may perform additional QA processing operations on the third set of data to generate a fourth set of data, which is then provided to the first computing device.

In certain embodiments, a first computing device (e.g., server 162) may receive a first set of data from the QA system 100, which is then processed and provided as a second set of data to another computing device (e.g., mainframe 158). The second set of data is processed by the second computing device to generate a third set of data, which is provided back to the first computing device. The second computing device then processes the third set of data to generate a fourth set of data, which is then provided to the QA system 100, where it is used to perform QA operations described in greater detail herein.

In one embodiment, the QA system may receive a first set of data from a first computing device (e.g., handheld computer/mobile device 150), which is then used to perform QA operations resulting in a second set of data. The second set of data is then provided back to the first computing device, where it is used to generate a third set of data. In turn, the third set of data is provided back to the QA system 100, which then provides it to a second computing device (e.g., mainframe computer 158), where it is used to perform post processing operations.

As an example, a content user 130 may ask the question, “I'm looking for a good pizza restaurant nearby.” In response, the QA system 100 may provide a list of three such restaurants in a half mile radius of the content user. In turn, the content user 130 may then select one of the recommended restaurants and ask for directions, signifying their intent to proceed to the selected restaurant. In this example, the list of recommended restaurants, and the restaurant the content user 130 selected, would be the third set of data provided to the QA system 100. To continue the example, the QA system 100 may then provide the third set of data to the second computing device, where it would be processed to generate a database of the most popular restaurants, by classification, location, and other criteria.

In various embodiments the exchange of data between various computing devices (e.g., 150, 152, 154, 156, 158, 162) results in more efficient processing of data as each of the computing devices can be optimized for the types of data it processes. Likewise, the most appropriate data for a particular purpose can be sourced from the most suitable computing device (e.g., 150, 152, 154, 156, 158, 162), or data source 166, thereby increasing processing efficiency. Skilled practitioners of the art will realize that many such embodiments are possible and that the foregoing is not intended to limit the spirit, scope or intent of the invention.

FIG. 2 illustrates an information processing system 202, more particularly, a processor and common components, which is a simplified example of a computer system capable of performing the computing operations described herein. Information processing system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information processing system 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing system 202) to send and receive network messages to the Internet using HyperText Transfer Protocol (HTTP) messaging, thus enabling communication with service provider server 252. In various embodiments, software programs 244 may also include meal kit personalization system 250. In these and other embodiments, the meal kit personalization system 250 includes code for implementing the processes described hereinbelow. In one embodiment, the information processing system 202 is able to download the meal kit personalization system 250 from a service provider server 252.

The hardware elements depicted in the information processing system 202 are not intended to be exhaustive, but rather are representative to highlight components used by the present invention. For instance, the information processing system 202 may include alternate memory storage devices such as magnetic cassettes, Digital Versatile Disks (DVDs), Bernoulli cartridges, and the like. These and other variations are intended to be within the spirit, scope and intent of the present invention.

The meal kit personalization system 250 performs a meal kit personalization operation. In certain embodiments the meal kit personalization system 250 executes as part of a QA system 100 to provide answers to a request to personalize recipes. In certain embodiments, the meal kit personalization operation includes receiving as an input recipe purchase history from one or more users and one or more recipes, identifying elements of the input recipes that could limit the appeal of the recipe to a user, generating alternative recipes based upon the input recipes and selecting a number of these input and alternative recipes for presentation to a particular user. In certain embodiments, the elements are identified based on a user purchase history. In certain embodiments, the alternative recipes are based on the input recipes and are generated using one or more ingredient substitutions, ingredient recombination, recipe simplification and recipe modification. In certain embodiments, the alternative recipes are evaluated to predict expected sales increase compare to the input recipes they are based on using purchase history data. In certain embodiments, a small number of the alternative recipes are presented to the particular user. In certain embodiments, the input recipes are selected using at least one of a recipe search engine and a recipe generator. In certain embodiments, the alternate recipe generation and recipe evaluation occur only after a user has been presented with the input recipes and has declined at least one input recipe.

Such a meal kit personalization operation provides a selection of the best ingredient candidates for substitution for a particular user or user cohort. Such a meal kit personalization operation calculates whether a particular user is likely to purchase a planned meal kit offering as is with no substitution so as to allow judicious selection of which members should be presented with the small number of alternatives. Such a meal kit personalization operation advantageously increases meal kit sales with minimal additional cost to the meal kit provider. Such a meal kit personalization operation advantageously minimally disrupts a meal kit provider's current workflow as it adds few extra steps to the provider's workflow.

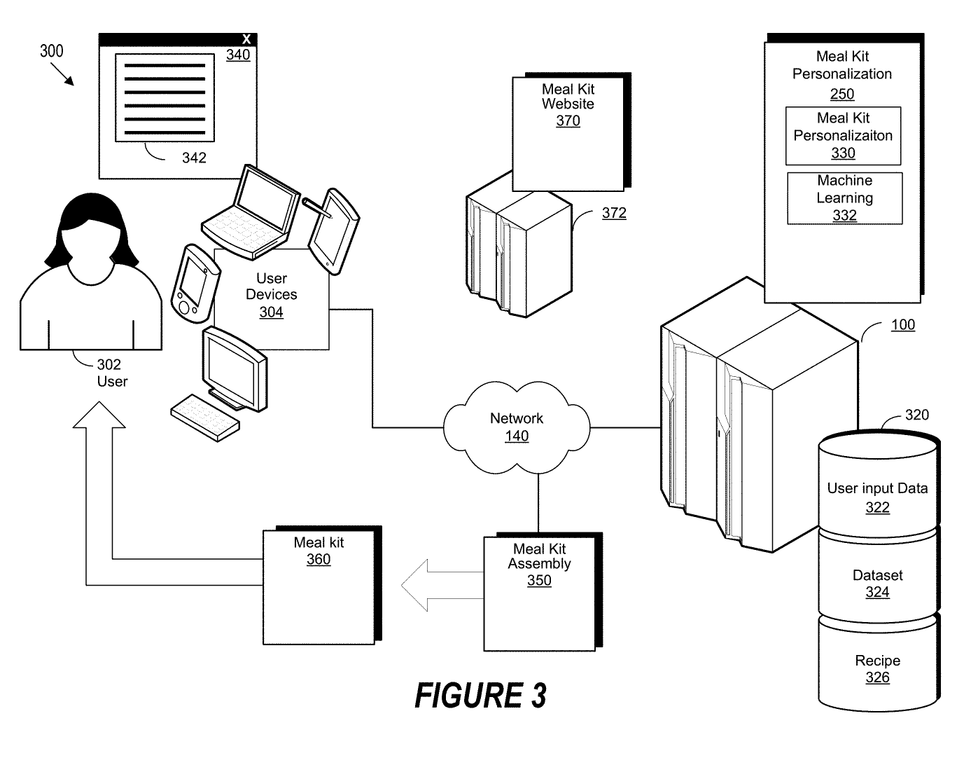

FIG. 3 is a block diagram of a meal kit personalization environment 300 implemented in accordance with an embodiment of the invention. The meal kit personalization environment 300 includes a meal kit personalization system 250.

In various embodiments, the meal kit personalization environment 300 includes a storage repository 320. The storage repository may be local to the system executing the meal kit personalization system 250 or may be executed remotely. In various embodiments, the storage repository includes one or more of a user input data repository 322, a dataset repository 324 and a recipe repository 326. In certain embodiments, the recipe repository 326 stores recipe and ingredient data which can be retrieved when performing the meal kit personalization operation.

In various embodiments, the meal kit personalization module 330 performs a meal kit personalization operation. The meal kit personalization system 250 also includes a machine learning engine 332 which interacts with the meal kit personalization module 330 when performing the meal kit personalization operation.

In various embodiments, the meal kit personalization environment 300 includes a meal kit website 370 executing on a meal kit server 372. In certain embodiments, one or both the meal kit personalization system 250 and the meal kit website 370 include at least one of a recipe search engine and a recipe generator.

In various embodiments, a user 302 accesses a meal kit provider to order one or more meal kits. In certain embodiments, the user 302 generates a meal kit personalization request. In certain embodiments, the interaction with the meal kit provider and the request are provided to one or more of the meal kit personalization system 250 and the meal kit website 370. In various embodiments, a meal kit personalization system 250 executes on a hardware processor of an information handling system 100. In various embodiments, the user 302 may use a user device 304 to interact with one or both of the meal kit personalization system 250 and the meal kit website 370.

As used herein, a user device 304 refers to an information handling system such as a personal computer, a laptop computer, a tablet computer, a personal digital assistant (PDA), a smart phone, a mobile telephone, or other device that is capable of communicating and processing data. In various embodiments, the user device is configured to present a meal kit personalization user interface 340. In various embodiments, the meal kit personalization user interface 340 presents a graphical representation 342 of meal kit personalization information which are automatically generated in response to interaction with the meal kit personalization system 250. In various embodiments, the user device 304 is used to exchange information between the user 302 and the meal kit personalization system 250 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention.

In various embodiments, the meal kit personalization system 250 interacts with a meal kit assembly system 350 which may be executing on a separate information handling system 100. In various embodiments, the meal kit assembly system 350 assembles meal kits 360 based upon the ingredients and recipes generated when performing the meal kit personalization operation. In various embodiments, the meal kit personalization user interface 340 may be presented via a website. In various embodiments, the website is provided by one or more of the meal kit personalization system 250 and a meal kit website 370 of a meal kit supplier.

For the purposes of this disclosure a website may be defined as a collection of related web pages which are identified with a common domain name and is published on at least one web server. A website may be accessible via a public internet protocol (IP) network or a private local network. A web page is a document which is accessible via a browser which displays the web page via a display device of an information handling system. In various embodiments, the web page also includes the file which causes the document to be presented via the browser. In various embodiments, the web page may comprise a static web page which is delivered exactly as stored and a dynamic web page which is generated by a web application that is driven by software that enhances the web page via user input to a web server.

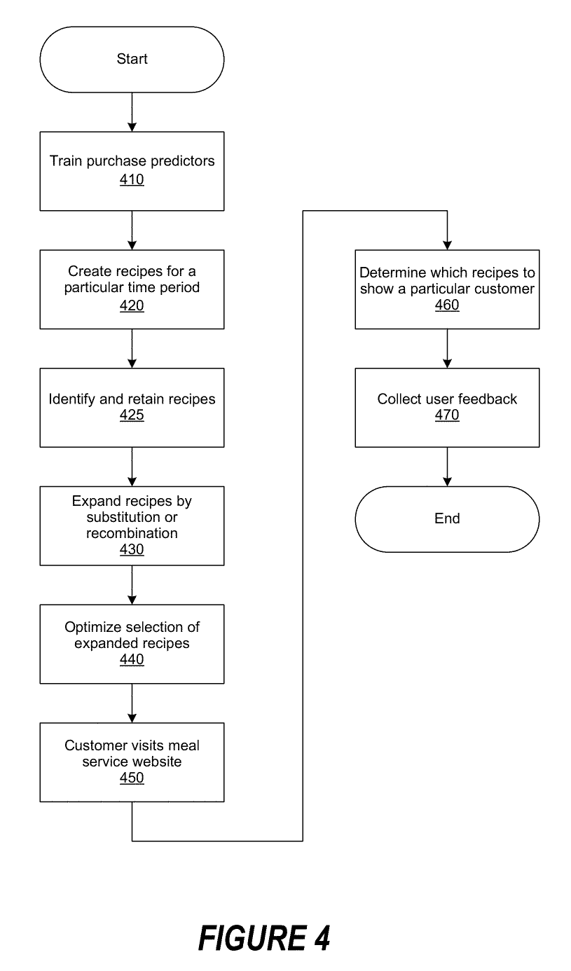

FIG. 4 is a generalized flowchart of the operation of meal kit personalization operation. The meal kit personalization operation 400 begins at step 410 with the meal kit personalization system 250 creating purchase predictors. A purchase predictor predicts whether a given user will select and buy a given meal. In certain embodiments, purchase predictors are created using collaborative filtering, the collaborative filters being built using one or more of the users' purchase history and past recipe ratings.

In certain embodiments, the predictors are models created using supervised machine learning techniques. Examples of supervised machine learning techniques include logistic regressions, decision trees, support vector machines, and neural networks. In certain embodiments, such purchase predictors are created for each existing user with sufficient purchase history. In certain embodiments, such purchase predictors are created for cohorts of existing users. For the purposes of the present disclosure a user cohort is a group of users who share one or more characteristics. In certain embodiments, a characteristic used to define a cohort is determined based upon the user's purchase history. In certain embodiments, when training the models, training data which includes one or both purchase history data and recipe rating data is used. In certain embodiments, the purchase history data and the recipe rating data are stored within the dataset repository 324.

In certain embodiments, the purchase predictor models include one or more features. In certain embodiments, the purchase predictor features include one or more of recipe ingredients, recipe photographs, preparation techniques, preparation durations, dish types, cuisines, time of year and location. In certain embodiments, the purchase predictors do not predict whether users will select a single recipe but whether the user with opt in or out of a particular period's offering. In certain embodiments, the purchase predictors can be used jointly to predict whether a given user will select and buy a given meal and whether the user with opt in or out of a particular period's offering.

Next at step 420, recipes for a particular time period are created and/or identified. In certain embodiments, the recipes are created by chefs associated with the meal kit delivery service. In certain embodiments, the recipes are created using computational creativity such as the technique for generating novel work products disclosed in U.S. Patent Application No 201/0199624A1, which is incorporated herein in its entirety. In certain embodiments, when evaluating the generated work products, the purchase predictors function as assessors. In certain embodiments, more recipes than are needed for a particular time period offering are created and/or identified. If more recipes than are needed are created and/or identified, then the meal kit personalization operation 400 identifies and retains the recipes with the best sales record at step 425 (e.g., within recipe repository 326).

Next, at step 430, the meal kit personalization operation expands the recipes for a particular time period by substituting or recombining ingredients. In certain embodiments, a substitute ingredient may be identified for all customers to increase a recipe purchase rate. For example, substitute ingredient recommendations may be provided via an ingredient substitution operation such as the technique for modifying recipes disclosed in U.S. Patent Application No 2016/0179935A1, which is incorporated herein in its entirety. The purchase predictors identified via the meal kit personalization operation are then used to determine which substitution will likely increase the purchase rate the most. Next, at step 432, the recipe is modified accordingly. For example, with a particular lasagna recipe, the meal kit personalization operation could determine that replacing thyme with basil would increase the purchase percentage for a lasagna meal kit by a certain percentage (e.g., by 10%). In certain embodiments, a substitute ingredient may be identified for certain customers to enable the meal kit provider to offer an alternate recipe for the certain customers thus increasing the combine purchase rate (e.g., the purchase rate for the input recipe and the alternate recipe). For example, with a particular lasagna recipe, the meal kit personalization operation might offer a vegan option rather than ground beef for certain customers. The meal kit personalization operation could determine that the combined purchase rate would increase by a certain percentage (e.g., by 15%).

In certain embodiments, for substitution operations, certain categories of ingredients can be given priority. For example, priority in the substituting ingredients might be given to non-perishable ingredients, to the most reusable ingredients (i.e., to ingredients that appear in the most recipes), to ingredients that are not the object of common dietary restrictions (e.g. ingredients that are not meat, pork, shellfish, or ingredients that do not contain gluten, etc.). In certain embodiments, where purchase predictors are implemented using weighted features (e.g., a linear regression operation or a support vector machine (SVM) operation), priority in the substituted ingredients can be given to the ingredients (or dishes or preparation methods) that represent the features with the most negative weights.

Next, at step 440, the meal kit personalization operation 400 optimizes the selection of expanded recipes to provide the meal kit provider with more profit. When substituting ingredients or changing recipes, the meal kit personalization operation 400 generates a plurality of recipe expansion suggestions. To attempt to provide increased profit, the meal kit personalization operation 400 calculates a purchase rate increase and an estimate revenue increase for the time period (compared to the original recipes). When optimizing the selection, the meal kit personalization operation 400 estimates a cost of implementation as well as an estimate profit increase. In certain embodiments, the cost of implementation includes one or more of a cost associated with creating the recipe, a cost for procuring the ingredients and a cost associated with waste when combining the ingredients into a meal kit. The meal kit personalization operation 400 then provides a suggestion of a combination of recipes that will maximize the profit increase.

Next, at step 450 a customer visits the meal kit web site 370 (e.g., via a user device 304) to make their selections for the time period. Next, at step 460, the meal kit personalization operation 400 determines which recipes to show to a particular customer. More specifically, the meal kit personalization operation uses purchase predictors to determine the top recipes for a particular customer and displays these recipes first. If a customer requests more options, then the meal kit personalization operation uses the purchase predictors to suggest a limited number of next best recipes. By providing a limited number of recipes the meal kit personalization operation limits decision fatigue by proposing a preferable number of choices as opposed to too much choice. In certain embodiments, the meal kit personalization operation 400 adjusts the number of recipes provided to a particular customer based upon learned shopping habits of the particular customer.

Next, at step 470 the meal kit personalization operation 400 collects user feedback. In certain embodiments, the user decisions based upon the interaction with the meal service web site are provided to retrain the purchase predictors. In certain embodiments, the meal kit personalization operation generates specific user questions to provide better accuracy when personalizing the meal kits based upon the purchase predictors. In certain embodiments, the specific user questions may be related to why a particular customer declines a particular recipe.

In certain embodiments, the ingredient substitution and recipe adjustments are made by the meal kit personalization operation while the customer is interacting on the meal service web site. For example, for some of the ingredients of a given recipe, a customer has the ability to request substitution suggestions. The pool of possible substitutions can be limited to a predefined list of available ingredients or to ingredients already used in other recipes for that time period.

Although the present invention has been described in detail, it should be understood that various changes, substitutions and alterations can be made hereto without departing from the spirit and scope of the invention as defined by the appended claims.

What is claimed is:

1. A computer-implemented method for performing a meal kit personalization operation, comprising:
receiving recipe purchase history information for a plurality of customers;
associating the recipe purchase history information with a plurality of input recipes;
identifying a plurality of input recipes for use for a particular time period;
identifying elements of the input recipes that limit appeal of each of the plurality of input recipes for the particular time period, the elements being identified using purchase predictor information relating to the elements;
generating alternative recipes based upon the input recipes; and
selecting a predefined number of these input recipes and alternative recipes for presentation to a particular user.

2. The method of claim 1, wherein:
the elements are identified based on a purchase history of the particular user.

3. The method of claim 1, wherein:
an alternative recipe is generated using one or more ingredient substitutions to the input recipe, ingredient recombination of the input recipe, recipe simplification of the input recipe and recipe modification of the input recipe.

4. The method of claim 1, wherein:
the alternative recipes are evaluated to predict expected sales increase compared to the input recipes they are based on using purchase history data.

5. The method of claim 1, wherein:
the predefined number of recipes comprises a small number of recipes.

6. The method of claim 1, wherein:
the input recipes are selected using at least one of a recipe search engine and a recipe generator.

7. A system comprising:
a processor;
a data bus coupled to the processor; and
a computer-usable medium embodying computer program code, the computer-usable medium being coupled to the data bus, the computer program code used for performing a meal kit personalization operation and comprising instructions executable by the processor and configured for:
receiving recipe purchase history information for a plurality of customers;
associating the recipe purchase history information with a plurality of input recipes;
identifying a plurality of input recipes for use for a particular time period;
identifying elements of the input recipes that limit appeal of each of the plurality of input recipes for the particular time period, the elements being identified using purchase predictor information relating to the elements;
generating alternative recipes based upon the input recipes; and
selecting a predefined number of these input recipes and alternative recipes for presentation to a particular user.

8. The system of claim 7, wherein:
the elements are identified based on a purchase history of the particular user.

9. The system of claim 7, wherein:
an alternative recipe is generated using one or more ingredient substitutions to the input recipe, ingredient recombination of the input recipe, recipe simplification of the input recipe and recipe modification of the input recipe.

10. The system of claim 7, wherein:
the alternative recipes are evaluated to predict expected sales increase compared to the input recipes they are based on using purchase history data.

11. The system of claim 7, wherein:
the predefined number of recipes comprises a small number of recipes.

12. The system of claim 7, wherein:
the input recipes are selected using at least one of a recipe search engine and a recipe generator.

13. A non-transitory, computer-readable storage medium embodying computer program code, the computer program code comprising computer executable instructions configured for:
receiving recipe purchase history information for a plurality of customers;
associating the recipe purchase history information with a plurality of input recipes;
identifying a plurality of input recipes for use for a particular time period;
identifying elements of the input recipes that limit appeal of each of the plurality of input recipes for the particular time period, the elements being identified using purchase predictor information relating to the elements;
generating alternative recipes based upon the input recipes; and
selecting a predefined number of these input recipes and alternative recipes for presentation to a particular user.

14. The non-transitory, computer-readable storage medium of claim 13, wherein:
the elements are identified based on a purchase history of the particular user.

15. The non-transitory, computer-readable storage medium of claim 13, wherein:
an alternative recipe is generated using one or more ingredient substitutions to the input recipe, ingredient recombination of the input recipe, recipe simplification of the input recipe and recipe modification of the input recipe.

16. The non-transitory, computer-readable storage medium of claim 13, wherein:
the alternative recipes are evaluated to predict expected sales increase compared to the input recipes they are based on using purchase history data.

17. The non-transitory, computer-readable storage medium of claim 13, wherein:
the predefined number of recipes comprises a small number of recipes.

18. The non-transitory, computer-readable storage medium of claim 13, wherein:
the input recipes are selected using at least one of a recipe search engine and a recipe generator.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
